(19) United States
(12) Patent Application Publication
(10) Pub. No.: US 2025/0358797 A1
(43) Pub. Date: Nov. 20, 2025

(54) METHOD AND DEVICE FOR TRANSMITTING TIME DOMAIN RESOURCE CONFIGURATION INFORMATION AND READABLE STORAGE MEDIUM

(71) Applicant: Beijing Xiaomi Mobile Software Co., Ltd., Beijing (CN)

(72) Inventor: Rui ZHOU, Beijing (CN)

(73) Assignee: Beijing Xiaomi Mobile Software Co., Ltd., Beijing (CN)

(21) Appl. No.: 18/873,016

(22) PCT Filed: Jun. 10, 2022
(86) PCT No.: PCT/CN2022/098160

§ 371 Date: Dec. 9, 2024

(51) Int. Cl. H04W 72/0446; H04L 5/00; H04W 72/21

(52) U.S. Cl. CPC H04W 72/0446; H04L 5/0051; H04W 72/21

(57) ABSTRACT

A method for transmitting time domain resource configuration information, includes: receiving time domain transmission configuration information transmitted by a network device, where the time domain transmission configuration information includes a first position, a second position, a third position, and a fourth position, where the first position indicates a time domain position of a last time domain unit occupied by a first SRS resource set in a first time slot, the second position indicates a time domain position of a first time domain unit occupied by a second SRS resource set in a second time slot, the third position indicates a starting position of a time domain interval for uplink channel transmission located between the first position and the second position, and the fourth position indicates an ending position of the time domain interval for uplink channel transmission located between the first position and the second position.

### CROSS-REFERENCE TO RELATED APPLICATIONS

The present application is a U.S. National Stage of International Application No. PCT/CN2022/098160, filed on Jun. 10, 2022, the contents of all of which are incorporated herein by reference in their entireties for all purposes.

### BACKGROUND OF THE INVENTION

A sounding reference signal (SRS) acts as a reference for determining a quality of an uplink channel by a base station, and assists in determination of a quality of a radio frequency transmission path between an antenna of a mobile terminal and an antenna of the base station. User equipment (UE) can be configured with a plurality of different SRS resource sets that are transmitted on different slots.

### SUMMARY OF THE INVENTION

The present disclosure relates to the technical field of radio communication, and in particular to a method and device for transmitting time domain resource configuration information, and a readable storage medium. The present disclosure provides a method and device for transmitting time domain resource configuration information, and a readable storage medium.

In a first aspect, the present disclosure provides a method for receiving time domain resource configuration information. The method is performed by user equipment and includes: receiving time domain transmission configuration information transmitted by a network device; where the time domain transmission configuration information includes a first position, a second position, a third position, and a fourth position; the first position is used to indicate a time domain position of a last time domain unit occupied by a first sounding reference signal (SRS) resource set in a first slot; the second position is used to indicate a time domain position of a first time domain unit occupied by a second SRS resource set in a second slot; the third position is used to indicate a starting position of a time domain interval for transmission of an uplink channel located between the first position and the second position; and the fourth position is used to indicate an ending position of the time domain interval for the transmission of the uplink channel located between the first position and the second position.

In a second aspect, the present disclosure provides a method for transmitting time domain resource configuration information. The method is performed by a network device and includes: transmitting time domain transmission configuration information to user equipment; where the time domain transmission configuration information includes a first position, a second position, a third position, and a fourth position; the first position is used to indicate a time domain position of a last time domain unit occupied by a first SRS resource set in a first slot; the second position is used to indicate a time domain position of a first time domain unit occupied by a second SRS resource set in a second slot; the third position is used to indicate a starting position of a time domain interval for transmission of an uplink channel located between the first position and the second position; and the fourth position is used to indicate an ending position of the time domain interval for the transmission of the uplink channel located between the first position and the second position.

In a third aspect, the present disclosure provides a communication device. The communication device includes one or more processors and a memory; where the memory is configured to store a computer program; and the one or more processors are collectively configured to execute the computer program, cause the communication device to: receive time domain transmission configuration information transmitted by a network device; where the time domain transmission configuration information includes a first position, a second position, a third position, and a fourth position; the first position is used to indicate a time domain position of a last time domain unit occupied by a first sounding reference signal (SRS) resource set in a first slot; the second position is used to indicate a time domain position of a first time domain unit occupied by a second SRS resource set in a second slot; the third position is used to indicate a starting position of a time domain interval for transmission of an uplink channel located between the first position and the second position; and the fourth position is used to indicate an ending position of the time domain interval for the transmission of the uplink channel located between the first position and the second position.

In a fourth aspect, the present disclosure provides a communication device. The communication device includes one or more processors and a memory; where the memory is configured to store a computer program; and the one or more processors are collectively configured to execute the computer program, cause the communication device to implement the second aspect or any possible design in the second aspect.

In a fifth aspect, the present disclosure provides a non-transitory computer-readable storage medium. The computer-readable storage medium stores one or more programs, where the one or more programs is configured to be executed by one or more processors of a processing device, and the one or more programs includes instructions, where the instructions, when executed by the processing device, cause the processing device to perform the first aspect or any possible design in the first aspect.

In a sixth aspect, the present disclosure provides a non-transitory computer-readable storage medium. The computer-readable storage medium stores one or more programs, where the one or more programs is configured to be executed by one or more processors of a processing device, and the one or more programs includes instructions, where the instructions, when executed by the processing device, cause the processing device to perform the second aspect or any possible design in the second aspect.

It should be understood that the general description and the following detailed description are merely illustrative and explanatory, and cannot limit the present disclosure.

### BRIEF DESCRIPTION OF DRAWINGS

The accompanying drawings described here, used for providing further understanding of examples of the present disclosure, constitute part of the present disclosure. Examples of the examples of the present disclosure and their descriptions serve to explain the examples of the present disclosure, instead of limiting the examples of the present disclosure improperly. In the accompanying drawings.

The accompanying drawings here are incorporated in the description as a constituent part of the description, illustrate examples conforming to the examples of the present disclosure, and serve to explain the principles in the examples of the present disclosure along with the description.

FIG. 1 is a schematic diagram of an architecture of a radio communication system according to an example of the present disclosure.

FIG. 2 is a flowchart of a method for transmitting time domain resource configuration information according to an example.

FIG. 3 is a flowchart of a method for receiving time domain resource configuration information according to an example.

FIG. 4 is a flowchart of a method for receiving time domain resource configuration information according to another example.

FIG. 5 is a schematic diagram of positions of consecutive slots according to an example.

FIG. 6 is a flowchart of a method for transmitting time domain resource configuration information according to an example.

FIG. 7 is a flowchart of a method for transmitting time domain resource configuration information according to another example.

FIG. 8 is a block diagram of a device for receiving time domain resource configuration information according to an example.

FIG. 9 is a block diagram of user equipment according to an example.

FIG. 10 is a block diagram of a device for transmitting time domain resource configuration information according to an example.

FIG. 11 is a block diagram of a communication device according to an example.

### DETAILED DESCRIPTION OF THE INVENTION

Examples of the present disclosure will be further described with reference to the accompanying drawings and particular embodiments.

Examples will be described in detail here, and illustratively shown in the accompanying drawings. When the following description relates to the accompanying drawings, the same numbers in different accompanying drawings denote the same or similar elements, unless indicated otherwise. The embodiments described in the examples below do not denote all embodiments consistent with the examples of the present disclosure. On the contrary, the embodiments are merely instances of devices and methods consistent with some aspects of the present disclosure as recited in the appended claims.

The terms used in the examples of the present disclosure are merely used to describe particular examples, rather than limit the examples of the present disclosure. The singular forms “a/an”, and “the” used in the examples of the present disclosure and the appended claims are also intended to include the plural forms, unless clearly stated in the context otherwise. It should also be understood that the term “and/or” used here indicates and encompasses one or any or all possible combinations of a plurality of associated items listed.

It should be understood that the terms first, second, third, etc. may be employed in the examples of the present disclosure to describe various information, but should not limit this information. These terms are merely used to distinguish the same type of information. For example, first information can also be referred to as second information, and similarly, second information can also be referred to as first information, without departing from the scope of the examples of the present disclosure. Depending on the context, the word “if” as used here can be interpreted as “at the time of”, “when”, or “in response to determining”.

The examples of the present disclosure are described in detail below, and illustratively shown in the accompanying drawings. The same or similar reference numerals denote the same or similar elements throughout. The examples described below with reference to the accompanying drawings are illustrative and intended to explain the present disclosure, but should not be interpreted as limiting the present disclosure.

Before the 3rd generation partnership project (3GPP) release 17 (Rel-17), each SRS resource set is configured at a set time domain position in a single slot. Thus, there is a time difference between SRS resource sets in adjacent slots. While in the 3GPP Rel-17, each SRS resource set can be configured at any position in a single slot. According to the 3GPP Rel-17, set guard interval can be configured for SRS resource sets in two consecutive slots, so that a symbol of interval between SRS resource sets in adjacent slots is not 0. In this scenario, it is a pressing issue to improve utilization efficiency of slots.

As shown in FIG. 1, a method for transmitting time domain resource configuration information according to an example of the present disclosure may be performed by a radio communication system 100. The radio communication system 100 may include user equipment 101 and a network device 102. The user equipment 101 is configured to support carrier aggregation, and can be connected to a plurality of carrier units, including one primary carrier unit and one or more secondary carrier units, of the network device 102.

It should be understood that the radio communication system 100 is applicable to a low-frequency scenario and a high-frequency scenario. Application scenarios of the radio communication system 100 include, but are not limited to, a long term evolution (LTE) system, an LTE frequency division duplex (FDD) system, an LTE time division duplex (TDD) system, a worldwide interoperability for micro wave access (WiMAX) communication system, a cloud radio access network (CRAN) system, a future 5th-generation (5G) system, a new radio (NR) communication system, a future evolved public land mobile network (PLMN) system, etc.

The user equipment 101 shown can be a terminal, an access terminal, a terminal unit, a terminal station, a mobile station (MS), a remote station, a remote terminal, a mobile terminal, a radio communication device, a terminal proxy, or a terminal device, etc. The user equipment 101 can have a radio transceiving function, perform communication (for example, radio communication) with one or more network devices of one or more communication systems, and receive network services provided by the network device. The network device here includes, but is not limited to, a network device 102 illustrated.

The user equipment 101 can be a cellular phone, a cordless phone, a session initiation protocol (SIP) phone, a wireless local loop (WLL) station, a personal digital assistant (PDA) device, a handheld device having a radio communication function, a computation device or other processing devices connected to a radio modem, a vehicle-mounted device, a wearable device, a terminal device in a future 5G network, a terminal device in a future evolved PLMN network, etc.

The network device 102 can be an access network device (or referred to as an access network site). The access network device indicates a device having a network access function, such as a radio access network (RAN) base station. The network device 102 can specifically include a base station (BS), or include a base station and a radio resource management device configured to control a base station etc. The network device 102 can further include a relay station (a relay device), an access point, a base station in the future 5G network, a base station in the future evolved PLMN network, an NR base station, etc. The network device 102 can be a wearable device or a vehicle-mounted device. The network device 102 can also be a communication chip having a communication module.

For example, the network device 102 includes, but is not limited to, a gnode B (gNB) in 5G, an evolved node B (eNB) in the LTE system, a radio network controller (RNC), a node B (NB) in a wide band code division multiple access (WCDMA) system, a radio controller in a cloud radio access network (CRAN) system, a base station controller (BSC), a base transceiver station (BTS) in a global system for mobile (GSM) or code division multiple access (CDMA) system, a home base station (for example, a home evolved node B or a home node B (HNB)), a baseband unit (BBU), a transmitting and receiving point (TRP), a transmitting point (TP), or a mobile switching center, etc.

A method for transmitting time domain resource configuration information is provided in the examples of the present disclosure. With reference to FIG. 2, a method for transmitting time domain resource configuration information according to an example is shown. As shown in FIG. 2, the method includes S201 and S202, specifically as follows.

In S201, the network device 102 transmits time domain transmission configuration information to the user equipment 101.

In S202, the user equipment 101 receives the time domain transmission configuration information transmitted by the network device 102. Where the time domain transmission configuration information includes a first position, a second position, a third position, and a fourth position. The first position is used to indicate a time domain position of a last time domain unit occupied by a first SRS resource set in a first slot (i.e., a slot is also referred to a time slot). The second position is used to indicate a time domain position of a first time domain unit occupied by a second SRS resource set in a second slot. The third position is used to indicate a starting position of a time domain interval for transmission of an uplink channel located between the first position and the second position. The fourth position is used to indicate an ending position of the time domain interval for the transmission of the uplink channel located between the first position and the second position.

In some possible embodiments, the first slot and the second slot are two consecutive slots.

In an instance, SlotN denotes the first slot, and SlotN+1 denotes the second slot.

In some possible embodiments, T1 symbols serve as interval between the first SRS resource set in the first slot and the second SRS resource set in the second slot. In other words, the interval T1 between the first position and the second position is greater than or equal to guard interval Y. If the interval between the first position and the second position is too large, a waste of transmission time resources will result.

In an instance, with reference to Table 1, a value of the guard interval Y and a value Δf of subcarrier spacing (SCS) are in a mapping correspondence relation.

TABLE 1

| μ | Δf = 2^{μ} * 15 (kHz) | Y (symbol) |
|---|---|---|
| 0 | 15 | 1 |
| 1 | 30 | 1 |
| 2 | 60 | 1 |
| 3 | 120 | 2 |

The μ is a configuration parameter for SCS. The value of the guard interval Y is in a range between 1 symbol and 2 symbols according to different kinds of SCS. The interval between the first position and the second position is greater than or equal to Y.

In some possible embodiments, the user equipment 101 may transmit an uplink channel signal between the third position and the fourth position.

In an instance, the user equipment 101 transmits a physical uplink shared channel (PUSCH) signal between the third position and the fourth position. In another instance, the user equipment 101 transmits a physical uplink control channel (PUCCH) signal between the third position and the fourth position.

In the example of the present disclosure, the network device 102 configures the third position and the fourth position in the interval between the first position and the second position separately. Thus, the user equipment 101 can perform uplink transmission by utilizing the interval between the SRS resource sets in the two consecutive slots, and the uplink channel signal can be transmitted by effectively and rationally utilizing the interval between the SRS resource sets in two adjacent slots. Accordingly, utilization efficiency of slots can be improved, and waste of transmission time resources can be reduced.

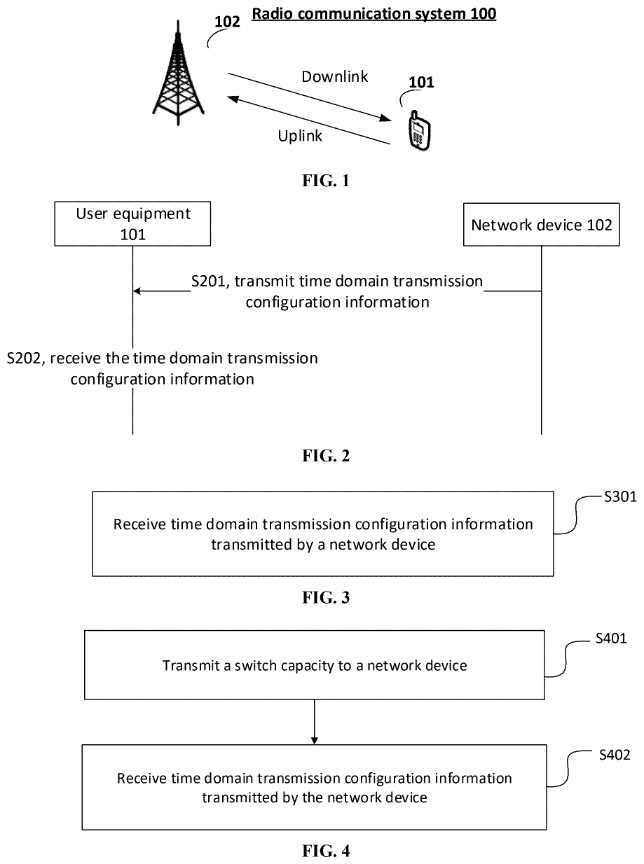

A method for receiving time domain resource configuration information is provided in the examples of the present disclosure. The method is performed by the user equipment 101. With reference to FIG. 3, a method for receiving time domain resource configuration information according to an example is shown. As shown in FIG. 3, the method includes S301, specifically as follows.

In S301, time domain transmission configuration information transmitted by the network device is received.

Where the time domain transmission configuration information includes a first position, a second position, a third position, and a fourth position. The first position is used to indicate a time domain position of a last time domain unit occupied by a first SRS resource set in a first slot. The second position is used to indicate a time domain position of a first time domain unit occupied by a second SRS resource set in a second slot. The third position is used to indicate a starting position of a time domain interval for transmission of an uplink channel located between the first position and the second position. The fourth position is used to indicate an ending position of the time domain interval for the transmission of the uplink channel located between the first position and the second position.

In some possible embodiments, interval T1 between the first position and the second position is greater than or equal to guard interval Y.

In some possible embodiments, the network device 102 may determine the first position and the second position in conjunction with the SRS resource sets configured, and configure the first position and the second position in the time domain transmission configuration information.

In some possible embodiments, the user equipment 101 may transmit the first SRS resource set before the first position in the first slot, and the second SRS resource set after the second position in the second slot. In some possible embodiments, in addition to transmission of the SRS resource set in the slot, the user equipment 101 may also transmit an uplink channel signal between the third position and the fourth position.

In an instance, the user equipment 101 transmits a physical uplink shared channel (PUSCH) signal between the third position and the fourth position.

In another instance, the user equipment 101 transmits a physical uplink control channel (PUCCH) signal between the third position and the fourth position.

In the example of the present disclosure, the user equipment 101 can obtain the starting position and the ending position for the uplink channel located between the first position and the second position according to the time domain transmission configuration information configured by the network device 102. Thus, the user equipment 101 can transmit the uplink channel signal by rationally utilizing interval between SRS resource sets in two adjacent slots. Accordingly, utilization efficiency of slots can be improved, and waste of transmission time resources can be reduced.

A method for receiving time domain resource configuration information is provided in the examples of the present disclosure. The method is performed by the user equipment 101. The method includes S301, where: the time domain interval between the first position and the third position is greater than first interval and guard interval in a case where a transmission antenna at the first position is the same as a transmission antenna of the uplink channel; the time domain interval between the first position and the third position is greater than second interval and guard interval in a case where a transmission antenna at the first position is different from a transmission antenna of the uplink channel; the time domain interval between the fourth position and the second position is greater than first interval and guard interval in a case where a transmission antenna of the uplink channel is the same as a transmission antenna at the second position; and the time domain interval between the fourth position and the second position is greater than second interval and guard interval in a case where a transmission antenna of the uplink channel is different from a transmission antenna at the second position.

In some possible embodiments, with reference to Table 1, a value of the guard interval Y and subcarrier spacing are in a mapping correspondence relation.

In some possible embodiments, the user equipment 101 may transmit the SRS resource set and the uplink channel signal by different transmission antennas.

In an example, the user equipment 101 transmits the first SRS resource set in the first slot by a first antenna, where the first antenna is the transmission antenna at the first position.

In an instance, the user equipment 101 transmits the uplink channel signal between the third position and the fourth position by a second antenna, where the second antenna is the transmission antenna of the uplink channel.

In an instance, the user equipment 101 transmits the second SRS resource set in the second slot by a third antenna, where the third antenna is the transmission antenna at the second position.

In some possible embodiments, when changing a type of the signal to be transmitted, for example, changing from transmitting the first SRS resource set to the uplink channel PUSCH or PUCCH signal, alternatively, changing from transmitting the uplink channel PUSCH or PUCCH signal to the second SRS resource set, the user equipment 101 may switch the transmission antenna for uplink transmission.

In an instance, the first antenna is the same as the second antenna, the time domain interval between the first position and the third position needs to be greater than a switch time required for the user equipment 101 to switch from transmitting the SRS resource set to the uplink channel signal in a case of a same antenna port, where the switch time is referred to as the first interval and denoted as SRSResourceSetSwitch-SA.

In an instance, the first antenna is different from the second antenna, the time domain interval between the first position and the third position needs to be greater than a switch time required for the user equipment 101 to switch from transmitting the SRS resource set to the uplink channel signal in a case of different antenna ports, where the switch time is referred to as the second interval and denoted as SRSResourceSetSwitch-DA.

In an instance, the second antenna is the same as the third antenna, the time domain interval between the fourth position and the second position needs to be greater than a switch time required for the user equipment 101 to switch from transmitting the uplink channel signal to the SRS resource set in a case of a same antenna port, where the switch time is still referred to as the first interval.

In an instance, the second antenna is different from the third antenna, the time domain interval between the fourth position and the second position needs to be greater than a switch time required for the user equipment 101 to switch from transmitting the uplink channel signal to the SRS resource set in a case of different antenna ports, where the switch time is still referred to as the second interval.

In the example of the present disclosure, according to the switch times when the user equipment 101 transmits different types of uplink signals in a case of the same antenna port or different antenna ports, the network device 102 adaptively configures the time domain interval between the first position and the third position, and the time domain interval between the second position and the fourth position. Thus, the user equipment 101 can complete switching between different types of uplink signals in a case of the same antenna port or different antenna ports in the time domain interval configured. Accordingly, the guard interval can be fully utilized, and a utilization rate of slots can be increased.

A method for receiving time domain resource configuration information is provided in the examples of the present disclosure. The method is performed by the user equipment 101. The method includes S301, specifically as follows.

The first interval and second interval are pre-configured; or first interval and second interval are determined according to a protocol. Then, in S301, time domain transmission configuration information transmitted by the network device is received. Where the time domain transmission configuration information includes a first position, a second position, a third position, and a fourth position. The first position is used to indicate a time domain position of a last time domain unit occupied by a first SRS resource set in a first slot. The second position is used to indicate a time domain position of a first time domain unit occupied by a second SRS resource set in a second slot. The third position is used to indicate a starting position of a time domain interval for transmission of an uplink channel located between the first position and the second position. The fourth position is used to indicate an ending position of the time domain interval for the transmission of the uplink channel located between the first position and the second position.

Where the time domain interval between the first position and the third position is greater than first interval and guard interval in a case where a transmission antenna at the first position is the same as a transmission antenna of the uplink channel; the time domain interval between the first position and the third position is greater than second interval and guard interval in a case where a transmission antenna at the first position is different from a transmission antenna of the uplink channel; the time domain interval between the fourth position and the second position is greater than first interval and guard interval in a case where a transmission antenna of the uplink channel is the same as a transmission antenna at the second position; and the time domain interval between the fourth position and the second position is greater than second interval and guard interval in a case where a transmission antenna of the uplink channel is different from a transmission antenna at the second position.

In some possible embodiments, the network device 102 pre-configures the first interval and the second interval.

In some possible embodiments, the first interval is a switch time required for switching between an SRS resource set and an uplink channel signal in a case of a same antenna port.

In some possible embodiments, the second interval is a switch time required for switching between the SRS resource set and an uplink channel signal in a case of different antenna ports.

In the example of the present disclosure, the first interval and the second interval are pre-configured by the network device 102 or determined according to the protocol. Thus, a utilization rate of slots can be increased on the basis of effectively reducing system overhead.

A method for receiving time domain resource configuration information is provided in the examples of the present disclosure. The method is performed by the user equipment 101. With reference to FIG. 4, a method for receiving time domain resource configuration information according to an example is shown. As shown in FIG. 4, the method includes S401-S402, specifically as follows.

In S401, the user equipment 101 transmits a switch capacity to the network device 102; where the switch capacity includes a first capacity and a second capacity; the first capacity is used to indicate time domain interval required for switching between an SRS resource set and an uplink channel in a case where an antenna of the SRS resource set is the same as an antenna of the uplink channel; and the second capacity is used to indicate time domain interval required for switching between the SRS resource set and an uplink channel in a case where the antenna of the SRS resource set is different from the antenna of the uplink channel.

In S402, time domain transmission configuration information transmitted by the network device is received. Where the time domain transmission configuration information includes a first position, a second position, a third position, and a fourth position. The first position is used to indicate a time domain position of a last time domain unit occupied by a first SRS resource set in a first slot. The second position is used to indicate a time domain position of a first time domain unit occupied by a second SRS resource set in a second slot. The third position is used to indicate a starting position of a time domain interval for transmission of the uplink channel located between the first position and the second position. The fourth position is used to indicate an ending position of the time domain interval for the transmission of the uplink channel located between the first position and the second position.

In some possible embodiments, the user equipment 101 reports the switch capacity through radio resource control (RRC) signaling.

In an instance, the user equipment 101 reports the switch capacity through RRC signaling, where the RRC signaling is denoted as SRSResourceSetSwitch.

In some possible embodiments, the time domain resource configuration information may further indicate transmission antennas used before and after the user equipment 101 switches types of signals to be transmitted.

In the example of the present disclosure, the user equipment 101 may report the switch capacity to the network device 102. Thus, the network device 102 adaptively configures the time domain transmission configuration information according to the switch capacity of the user equipment 101, and the time domain transmission configuration information is applicable to the user equipment 101 having different switch capacities. Accordingly, the user equipment 101 having different switch capacities can transmit different types of uplink signal based on their own switch capacities.

A method for receiving time domain resource configuration information is provided in the examples of the present disclosure. The method is performed by the user equipment 101. The method includes S401-S402, specifically as follows.

In S401, the user equipment 101 transmits a switch capacity to the network device 102; where the switch capacity includes a first capacity and a second capacity; the first capacity is used to indicate time domain interval required for switching between an SRS resource set and an uplink channel in a case where an antenna of the SRS resource set is the same as an antenna of the uplink channel; and the second capacity is used to indicate time domain interval required for switching between the SRS resource set and an uplink channel in a case where the antenna of the SRS resource set is different from the antenna of the uplink channel.

In S402, time domain transmission configuration information transmitted by the network device is received. Where the time domain transmission configuration information includes a first position, a second position, a third position, and a fourth position. The first position is used to indicate a time domain position of a last time domain unit occupied by a first SRS resource set in a first slot. The second position is used to indicate a time domain position of a first time domain unit occupied by a second SRS resource set in a second slot. The third position is used to indicate a starting position of a time domain interval for transmission of the uplink channel located between the first position and the second position. The fourth position is used to indicate an ending position of the time domain interval for the transmission of the uplink channel located between the first position and the second position.

In the method, the time domain interval between the first position and the third position is greater than the time domain interval indicated by the first capacity and greater than guard interval in a case where a transmission antenna at the first position is the same as a transmission antenna of the uplink channel; the time domain interval between the first position and the third position is greater than the time domain interval indicated by the second capacity and greater than guard interval in a case where a transmission antenna at the first position is different from a transmission antenna of the uplink channel; the time domain interval between the fourth position and the second position is greater than the time domain interval indicated by the first capacity and greater than guard interval in a case where a transmission antenna of the uplink channel is the same as a transmission antenna at the second position; and the time domain interval between the fourth position and the second position is greater than the time domain interval indicated by the second capacity and greater than guard interval in a case where a transmission antenna of the uplink channel is different from a transmission antenna at the second position.

In some possible embodiments, with reference to Table 1, a value of the guard interval Y and subcarrier spacing are in a mapping correspondence relation.

In some possible embodiments, the uplink channel includes a PUSCH or a PUCCH.

In an instance, the first capacity indicates a switch time, e.g., SRSResourceSetSwitch-SA, required for the user equipment 101 to switch between the SRS resource set and a PUSCH or PUCCH signal in a case of a same antenna port.

In an instance, the second capacity indicates a switch time, e.g., SRSResourceSetSwitch-DA, required for the user equipment 101 to switch between the SRS resource set and a PUSCH or PUCCH signal in a case of different antenna ports.

In the example of the present disclosure, according to the switch capacities of the user equipment 101 in a case of transmitting different types of uplink signals in a case of the same antenna port or different antenna ports, the network device 102 adaptively configures the time domain interval between the first position and the third position, and the time domain interval between the second position and the fourth position. Thus, the user equipment 101 can complete switching between different types of uplink signals in a case of the same antenna port or different antenna ports in the time domain interval configured. Accordingly, the guard interval can be fully utilized, and a utilization rate of slots can be increased.

In order to facilitate understanding of the examples of the present disclosure, specific instances are listed below for description.

### Instance 1:

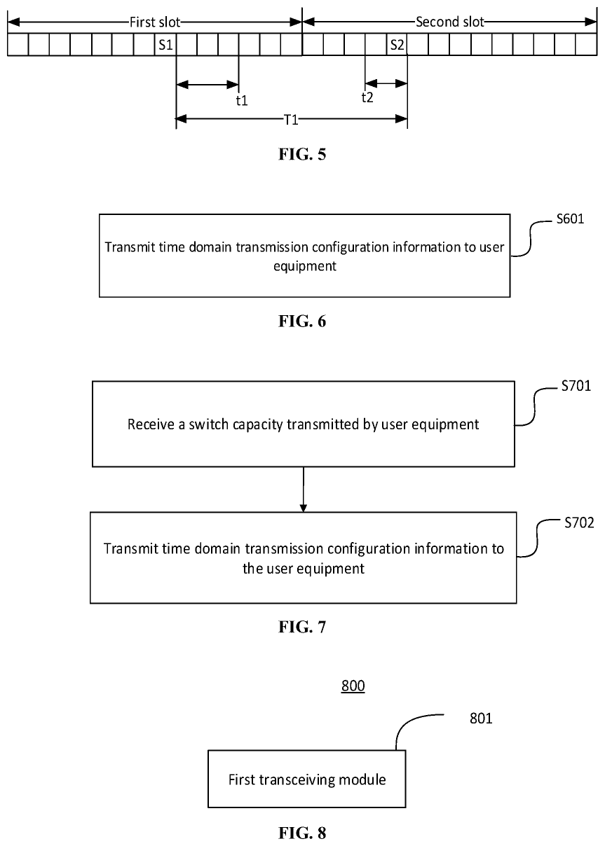

In conjunction with FIG. 5, SlotN denotes a first slot, and SlotN+1 denotes a second slot.

The Instance 1 may include: the network device 102 configures time domain transmission configuration information, and transmits the time domain transmission configuration information to the user equipment 101.

The time domain transmission configuration information indicates information as follows: a time domain position of a last time domain unit occupied by a first SRS resource set in the first slot SlotN, and S1 denotes a first position; and a time domain position of a first time domain unit occupied by a second SRS resource set in the second slot SlotN+1, S2 denotes a second position, t1 denotes a third position, and t2 denotes a fourth position.

The time domain transmission configuration information further indicates first interval, e.g., SRSResourceSetSwitch-SA, in a case that a first antenna is the same as a second antenna, and second interval, e.g., SRSResourceSetSwitch-DA, in a case that the first antenna is different from the second antenna; and first interval in a case that the second antenna is the same as a third antenna, and second interval in a case that the second antenna is different from the third antenna. A transmission antenna transmitting the first SRS resource set at the first position is the first antenna, a transmission antenna transmitting a PUSCH or PUCCH signal between the third position and the fourth position is the second antenna, and a transmission antenna transmitting the second SRS resource set at the second position is the third antenna.

The user equipment 101 transmits the PUSCH or PUCCH signal between the third position t1 and the fourth position t2 according to the time domain transmission configuration information of the network device 102, and may determine whether to switch the antenna according to an indication of the time domain transmission configuration information.

In the instance, the network device 102 configures a plurality of positions, the first interval, and the second interval in the time domain transmission configuration information, the user equipment 101 may transmit the PUSCH or PUCCH signal in the interval configured to transmit the SRS resource set according to the time domain transmission configuration information. Accordingly, the interval between the first position S1 and the second position S2 is fully utilized. In the instance, system overhead is effectively reduced on the basis of increasing a utilization rate of slots.

### Instance 2:

In conjunction with FIG. 5, SlotN denotes a first slot, and SlotN+1 denotes a second slot.

The Instance 2 may include: the user equipment 101 reports a switch capacity to the network device 102 by transmitting RRC signaling, e.g., SRSResourceSetSwitch; where the switch capacity may include a first capacity and a second capacity; the first capacity is used to indicate time domain interval, e.g., SRSResourceSetSwitch-SA, required for switching between an SRS resource set and an uplink channel in a case where an antenna of the SRS resource set is the same as an antenna of the uplink channel; and the second capacity is used to indicate time domain interval, e.g., SRSResourceSetSwitch-DA, required for switching between the SRS resource set and an uplink channel in a case where the antenna of the SRS resource set is different from the antenna of the uplink channel.

The network device 102 configures time domain transmission configuration information according to the switch capacity, and transmits the time domain transmission configuration information to the user equipment 101; where the time domain transmission configuration information indicates information as follows: a time domain position of a last time domain unit occupied by a first SRS resource set in the first slot SlotN, and S1 denotes a first position; and a time domain position of a first time domain unit occupied by a second SRS resource set in the second slot SlotN+1, S2 denotes a second position, t1 denotes a third position, and t2 denotes a fourth position.

In addition, according to the first capacity and the second capacity, the network device 102 further configures, in the time domain transmission configuration information, a relation of time domain interval in a case that a first antenna is the same as or different from a second antenna, and interval indicated by the first capacity or the second capacity; and a relation of time domain interval in a case that a second antenna is the same as or different from a third antenna, and interval indicated by the first capacity or the second capacity. A transmission antenna transmitting the first SRS resource set at the first position is the first antenna, a transmission antenna transmitting a PUSCH or PUCCH signal between the third position and the fourth position is the second antenna, and a transmission antenna transmitting the second SRS resource set at the second position is the third antenna.

The user equipment 101 transmits the PUSCH or PUCCH signal between the third position t1 and the fourth position t2 according to the time domain transmission configuration information, and may determine whether to switch the antenna according to an indication of the time domain transmission configuration information.

In the instance, the network device 102 adaptively configures the time domain transmission configuration information according to the switch capacity of the user equipment 101. Thus, the user equipment 101 can transmit the PUSCH or the PUCCH signal by fully utilizing the interval between the first position S1 and the second position S2 within the scope of its own switch capacity. It is ensured that the user equipment 101 can transmit an uplink channel signal according to its own capacity and the configuration of the network device 102, on the basis of increasing a utilization rate of slots. In conjunction with the time domain transmission configuration information configured to which the switch capacity of the user equipment 101 is adapted, a too long switch time configured can be avoided, and transmission time resources can be further saved on.

A method for transmitting time domain resource configuration information is provided in the examples of the present disclosure. The method is performed by the network device 102. With reference to FIG. 6, a method for transmitting time domain resource configuration information according to an example is shown. As shown in FIG. 6, the method includes S601, specifically as follows.

S601, the network device 102 transmits time domain transmission configuration information to the user equipment 101. Where the time domain transmission configuration information includes a first position, a second position, a third position, and a fourth position. The first position is used to indicate a time domain position of a last time domain unit occupied by a first SRS resource set in a first slot. The second position is used to indicate a time domain position of a first time domain unit occupied by a second SRS resource set in a second slot. The third position is used to indicate a starting position of a time domain interval for transmission of an uplink channel located between the first position and the second position. The fourth position is used to indicate an ending position of the time domain interval for the transmission of the uplink channel located between the first position and the second position.

In the method of the present disclosure, the network device 102 indicates the starting position and the ending position for the uplink channel located between the first position and the second position to the user equipment 101 by transmitting the time domain transmission configuration information. Thus, the user equipment 101 can transmit an uplink channel signal by rationally utilizing interval between SRS resource sets in two adjacent slots according to the time domain transmission configuration information. Accordingly, utilization efficiency of slots can be improved, and waste of transmission time resources can be reduced.

A method for transmitting time domain resource configuration information is provided in the examples of the present disclosure. The method is performed by the network device 102. The method includes S601, where the time domain interval between the first position and the third position is greater than first interval and guard interval in a case where a transmission antenna at the first position is the same as a transmission antenna of the uplink channel; the time domain interval between the first position and the third position is greater than second interval and guard interval in a case where a transmission antenna at the first position is different from a transmission antenna of the uplink channel; the time domain interval between the fourth position and the second position is greater than first interval and guard interval in a case where a transmission antenna of the uplink channel is the same as a transmission antenna at the second position; and the time domain interval between the fourth position and the second position is greater than second interval and guard interval in a case where a transmission antenna of the uplink channel is different from a transmission antenna at the second position.

In the example of the present disclosure, according to switch times when the user equipment 101 transmits different types of uplink signals in a case of a same antenna port or different antenna ports, the network device 102 adaptively configures the time domain interval between the first position and the third position, and the time domain interval between the second position and the fourth position. Thus, the user equipment 101 can complete switching between different types of uplink signals in a case of the same antenna port or different antenna ports in the time domain interval configured. Accordingly, the guard interval can be fully utilized, and a utilization rate of slots can be increased.

A method for transmitting time domain resource configuration information is provided in the examples of the present disclosure. The method is performed by the network device 102. The method includes S601, specifically as follows.

The first interval and second interval pre-configured are determined; or first interval and second interval are determined according to a protocol. In S601, the network device 102 transmits time domain transmission configuration information to the user equipment 101. Where the time domain transmission configuration information includes a first position, a second position, a third position, and a fourth position. The first position is used to indicate a time domain position of a last time domain unit occupied by a first SRS resource set in a first slot. The second position is used to indicate a time domain position of a first time domain unit occupied by a second SRS resource set in a second slot. The third position is used to indicate a starting position of a time domain interval for transmission of an uplink channel located between the first position and the second position. The fourth position is used to indicate an ending position of the time domain interval for the transmission of the uplink channel located between the first position and the second position.

In the example of the present disclosure, the first interval and the second interval are pre-configured by the network device 102 or determined according to the protocol. Thus, a utilization rate of slots can be increased on the basis of effectively reducing system overhead.

A method for transmitting time domain resource configuration information is provided in the examples of the present disclosure. The method is performed by the network device 102. With reference to FIG. 7, a method for transmitting time domain resource configuration information according to an example is shown. As shown in FIG. 7, the method includes S701-S702, specifically as follows.

In S701, the network device 102 receives a switch capacity transmitted by the user equipment 101. Where the switch capacity includes a first capacity and a second capacity; the first capacity is used to indicate time domain interval required for switching between an SRS resource set and an uplink channel in a case where an antenna of the SRS resource set is the same as an antenna of the uplink channel; and the second capacity is used to indicate time domain interval required for switching between the SRS resource set and an uplink channel in a case where the antenna of the SRS resource set is different from the antenna of the uplink channel.

In S702, the network device 102 transmits time domain transmission configuration information to the user equipment 101. Where the time domain transmission configuration information includes a first position, a second position, a third position, and a fourth position. The first position is used to indicate a time domain position of a last time domain unit occupied by a first SRS resource set in a first slot. The second position is used to indicate a time domain position of a first time domain unit occupied by a second SRS resource set in a second slot. The third position is used to indicate a starting position of a time domain interval for transmission of the uplink channel located between the first position and the second position. The fourth position is used to indicate an ending position of the time domain interval for the transmission of the uplink channel located between the first position and the second position.

In the example of the present disclosure, the network device 102 adaptively configures the time domain transmission configuration information for different kinds of user equipment 101 according to the switch capacity reported by the user equipment 101, and the time domain transmission configuration information is applicable to the user equipment 101 having different switch capacities. Accordingly, the user equipment 101 having different switch capacities can transmit different types of uplink signal based on their own switch capacities.

A method for transmitting time domain resource configuration information is provided in the examples of the present disclosure. The method is performed by the network device 102. The method includes S701-S702, specifically as follows.

S701, the network device 102 receives a switch capacity transmitted by the user equipment 101. Where the switch capacity includes a first capacity and a second capacity; the first capacity is used to indicate time domain interval required for switching between an SRS resource set and an uplink channel in a case where an antenna of the SRS resource set is the same as an antenna of the uplink channel; and the second capacity is used to indicate time domain interval required for switching between the SRS resource set and an uplink channel in a case where the antenna of the SRS resource set is different from the antenna of the uplink channel.

S702, the network device 102 transmits time domain transmission configuration information to the user equipment 101. Where the time domain transmission configuration information includes a first position, a second position, a third position, and a fourth position. The first position is used to indicate a time domain position of a last time domain unit occupied by a first SRS resource set in a first slot. The second position is used to indicate a time domain position of a first time domain unit occupied by a second SRS resource set in a second slot. The third position is used to indicate a starting position of a time domain interval for transmission of the uplink channel located between the first position and the second position. The fourth position is used to indicate an ending position of the time domain interval for the transmission of the uplink channel located between the first position and the second position.

In the method, the time domain interval between the first position and the third position is greater than the time domain interval indicated by the first capacity and greater than guard interval in a case where a transmission antenna at the first position is the same as a transmission antenna of the uplink channel; the time domain interval between the first position and the third position is greater than the time domain interval indicated by the second capacity and greater than guard interval in a case where a transmission antenna at the first position is different from a transmission antenna of the uplink channel; the time domain interval between the fourth position and the second position is greater than the time domain interval indicated by the first capacity and greater than guard interval in a case where a transmission antenna of the uplink channel is the same as a transmission antenna at the second position; and the time domain interval between the fourth position and the second position is greater than the time domain interval indicated by the second capacity and greater than guard interval in a case where a transmission antenna of the uplink channel is different from a transmission antenna at the second position.

In the example of the present disclosure, according to switch capacities of the user equipment 101 in a case of transmitting different types of uplink signals in a case of a same antenna port or different antenna ports, the network device 102 adaptively configures the time domain interval between the first position and the third position, and the time domain interval between the second position and the fourth position. Thus, the user equipment 101 can complete switching between different types of uplink signals in a case of the same antenna port or different antenna ports in the time domain interval configured. Accordingly, the guard interval can be fully utilized, and a utilization rate of slots can be increased.

On the basis of the same concept as that in the previous method examples, a device for receiving time domain resource configuration information is further provided in the examples of the present disclosure. The device may have functions of the user equipment 101 in the method examples, and may be configured to perform steps performed by the user equipment 101 and provided in the previous method examples. The function may be implemented through hardware or software, or by executing corresponding software by hardware. The hardware or software includes one or more modules corresponding to the function.

In a possible embodiment, the device 800 shown in FIG. 8 may serve as the user equipment 101 involved in the method examples, and perform the steps performed by the user equipment 101 in the method examples. As shown in FIG. 8, the device 800 may include a first transceiving module 801. The first transceiving module 801 may be configured to support the device 800 in communication. The first transceiving module 801 may have a radio communication function of performing radio communication with other communication devices by a radio, etc.

When performing the steps implemented by the user equipment 101, the first transceiving module 801 is configured to receive time domain transmission configuration information transmitted by the network device 102. Where the time domain transmission configuration information includes a first position, a second position, a third position, and a fourth position. The first position is used to indicate a time domain position of a last time domain unit occupied by a first SRS resource set in a first slot. The second position is used to indicate a time domain position of a first time domain unit occupied by a second SRS resource set in a second slot. The third position is used to indicate a starting position of a time domain interval for transmission of an uplink channel located between the first position and the second position. The fourth position is used to indicate an ending position of the time domain interval for the transmission of the uplink channel located between the first position and the second position.

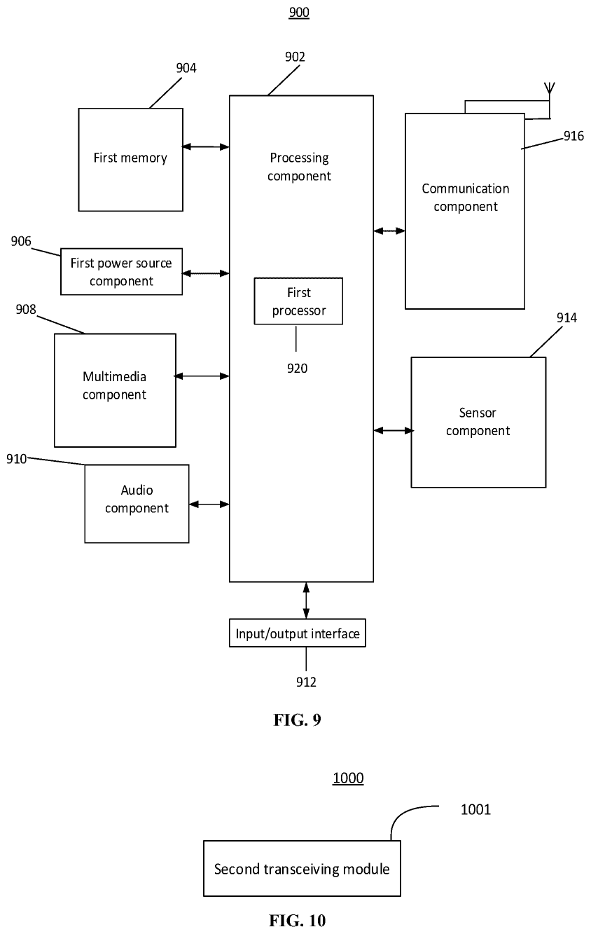

When being the user equipment 101, the device receiving the configuration information may also be structurally shown in FIG. 9. The device 900 may be a mobile phone, a computer, a digital broadcast terminal, a messaging device, a gaming console, a tablet device, a medical device, a fitness device, a personal digital assistant, etc.

With reference to FIG. 9, the device 900 may include one or more components as follows: a processing component 902, a first memory 904, a first power source component 906, a multimedia component 908, an audio component 910, an input/output (I/O) interface 912, a sensor component 914, and a communication component 916.

Generally, the processing component 902 controls an overall operation of the device 900, such as operations associated with display, telephone calls, data communication, camera operations, and recording operations. The processing component 902 may include one or more first processors 920 to execute an instruction, so as to complete all or some of the steps in the methods. In addition, the processing component 902 may include one or more modules, so as to facilitate interactions between the processing component 902 and other components. For example, the processing component 902 may include a multimedia module, so as to facilitate the interaction between the multimedia component 908 and the processing component 902.

The first memory 904 is configured to store various types of data to support operations on the device 900. Instances of such data include an instruction operated on the device 900 for any application or method, contact data, phonebook data, messages, pictures, video, etc. The first memory 904 may be implemented through any type of volatile or non-volatile storage devices or their combination, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, and an optical disk.

The first power source component 906 provides power for various components of the device 900. The first power source component 906 may include a power source management system, one or more power sources, and other components associated with power generation, management, and distribution for the device 900.

The multimedia component 908 includes a screen that provides an output interface between the device 900 and a user. In some examples, the screen may include a liquid crystal display (LCD) and a touch panel (TP). If including the touch panel, the screen may be implemented as a touch screen, so as to receive an input signal from the user. The touch panel includes one or more touch sensors, so as to sense touches, swipes, and gestures on the touch panel. The touch sensor may sense a boundary of a touch or swipe action, and measure duration and pressure associated with a touch or swipe operation. In some examples, the multimedia component 908 includes a front-facing camera and/or a rear-facing camera. When the device 900 is in an operation mode, such as a photographing mode or a video mode, the front-facing camera and/or the rear-facing camera may receive external multimedia data. Each of the front-facing camera and the rear-facing camera may be a fixed optical lens system or have a focal length and an optical zooming capacity.

The audio component 910 is configured to output and/or input audio signals. For example, the audio component 910 includes a microphone (MIC) configured to receive external audio signals when the device 900 is in the operation mode, for example, a calling mode, a recording mode, and a speech recognition mode. The audio signals received may be further stored in the first memory 904 or transmitted via the communication component 916. In some examples, the audio component 910 further includes a speaker configured to output audio signals.

The I/O interface 912 provides an interface between the processing component 902 and a peripheral interface module. The peripheral interface module may be a keyboard, a click wheel, a button, etc. These buttons may include, but are not limited to, a home button, a volume button, a start button, and a lock button.

The sensor component 914 includes one or more sensors configured to provide state assessments for various aspects of the device 900. For example, the sensor component 914 may detect an open/closed state of the device 900, and relative location of components, for example, a display and keypad of the device 900. The sensor component 914 may further detect a change in position of the device 900 or a component of the device 900, presence or absence of contact between the user and the device 900, orientation or acceleration/deceleration of the device 900, and a change in temperature of the device 900. The sensor component 914 may include a proximity sensor configured to detect presence of nearby objects in the absence of any physical contact. The sensor component 914 may further include a light sensor, such as a complementary metal-oxide-semiconductor transistor (CMOS) or charge coupled device (CCD) image sensor configured to be used in imaging application. In some examples, the sensor component 914 may further include an acceleration sensor, a gyroscope sensor, a magnetic sensor, a pressure sensor, or a temperature sensor.

The communication component 916 is configured to facilitate wired or radio communication between the device 900 and other devices. The device 900 may access a wireless network based on a communication standard, for example, a wireless fidelity (Wi-Fi) network, a 2nd generation (2G) network, or a 3rd generation (3G) network, or their combinations. In an example, the communication component 916 receives a broadcast signal or broadcast related information from an external broadcast management system via a broadcast channel. In an example, the communication component 916 further includes a near field communication (NFC) module, so as to facilitate short-range communication. For example, the NFC module may be implemented on the basis of a radio frequency identification (RFID) technology, an infrared data association (IrDA) technology, an ultra wide band (UWB) technology, a Bluetooth (BT) technology, etc.

In an example, the device 900 may be configured to perform the methods by being implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, etc.

A non-transitory computer-readable storage medium including an instruction, for example, the first memory 904 including an instruction is further provided in the examples. The instruction may complete the methods by being executed by the first processor 920 of the device 900. For example, the non-transitory computer-readable storage medium may be an ROM, a random access memory (RAM), a compact disk read-only memory (CD-ROM), a magnetic tape, a floppy disk, an optical data storage device, etc.

On the basis of the same concept as that in the method examples, a device for transmitting time domain resource configuration information is further provided in the examples of the present disclosure. The device may have a function of the network device 102 in the method examples, and may be configured to perform steps performed by the network device 102 and provided in the method examples. The function may be implemented through hardware or software, or by executing corresponding software by hardware. The hardware or software includes one or more modules corresponding to the function.

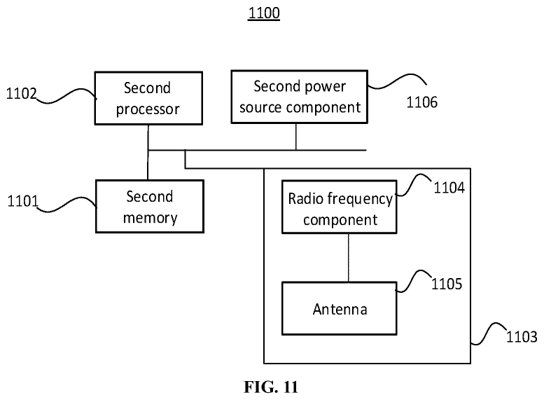

In a possible embodiment, the device 1000 shown in FIG. 10 may serve as the network device 102 involved in the method examples, and perform the steps performed by the network device 102 in the method examples. As shown in FIG. 10, the device 1000 may include a second transceiving module 1001. The second transceiving module 1001 may be configured to support the device 1000 in communication. The second transceiving module 1001 may have a radio communication function of performing radio communication with other communication devices by radio, etc.

When performing the steps implemented by the network device 102, the second transceiving module 1001 is configured to transmit time domain transmission configuration information to the user equipment 101. Where the time domain transmission configuration information includes a first position, a second position, a third position, and a fourth position. The first position is used to indicate a time domain position of a last time domain unit occupied by a first SRS resource set in a first slot. The second position is used to indicate a time domain position of a first time domain unit occupied by a second SRS resource set in a second slot. The third position is used to indicate a starting position of a time domain interval for transmission of an uplink channel located between the first position and the second position. The fourth position is used to indicate an ending position of the time domain interval for the transmission of the uplink channel located between the first position and the second position.

When being the network device 102, the device may also be structurally shown in FIG. 11. The communication device 1100 is structurally described with the base station as an example. As shown in FIG. 11, the device 1100 includes a second memory 1101, a second processor 1102, a transceiving component 1103, and a second power source component 1106. The second memory 1101 is coupled to the second processor 1102, and may be configured to store programs and data necessary for the communication device 1100 to implement various functions. The second processor 1102 is configured to support the communication device 1100 in performing corresponding functions in the methods. The functions may be implemented by invoking the programs stored in the second memory 1101. The transceiving component 1103 may be a radio transceiver, and may be configured to support the communication device 1100 in receiving signaling and/or data and transmitting signaling and/or data by a radio. The transceiving component 1103 may also be referred to as a transceiving unit or a communication unit. The transceiving component 1103 may include a radio frequency component 1104 and one or more antennas 1105. The radio frequency component 1104 may be a remote radio unit (RRU), and may be specifically configured to transmit a radio frequency signal and configured for conversion between a radio frequency signal and a baseband signal. One or more antennas 1105 may be specifically configured to radiate and receive the radio frequency signal.

When the communication device 1100 is required to transmit data, the second processor 1102 may perform baseband processing on the data to be transmitted, and output a baseband signal to the radio frequency unit. The radio frequency unit may perform radio frequency processing on the baseband signal, and transmit a radio frequency signal in a form of electromagnetic waves through the antenna. When data are to be transmitted to the communication device 1100, the radio frequency unit may receive a radio frequency signal through the antenna, convert the radio frequency signal into a baseband signal, and output the baseband signal to the second processor 1102. The second processor 1102 may convert the baseband signal into data, and process the data.

Those skilled in the art will readily conceive of other embodiments of the examples of the present disclosure after considering the description and practice of the invention disclosed here. The present disclosure is intended to cover any variations, uses, or adaptive changes in the examples of the present disclosure. These variations, uses, or adaptive changes follow the general principles in the examples of the present disclosure and include common general knowledge or customary technical means in the art not disclosed in the present disclosure. The description and the examples are merely deemed illustrative, and the true scope and spirit in the examples of the present disclosure are indicated by the following claims.

It should be understood that the examples of the present disclosure are not limited to precise structures that have been described and shown in the accompanying drawings, and various modifications and changes can be made without departing from the scope of the present disclosure. The scope in the examples of the present disclosure is limited merely by the appended claims.

### INDUSTRIAL APPLICABILITY

In the methods of the present disclosure, the user equipment can obtain the starting position and the ending position for the uplink channel located between the first position and the second position according to the time domain transmission configuration information configured by the network device. Thus, the user equipment can transmit the uplink channel signal by rationally utilizing the interval between the SRS resource sets in two adjacent slots. Accordingly, utilization efficiency of slots can be improved, and waste of transmission time resources can be reduced.

1. A method for receiving time domain resource configuration information, performed by user equipment, comprising:
receiving time domain transmission configuration information transmitted by a network device, and the time domain transmission configuration information comprises a first position, a second position, a third position, and a fourth position, wherein
the first position is used to indicate a time domain position of a last time domain unit occupied by a first sounding reference signal (SRS) resource set in a first slot,
the second position is used to indicate a time domain position of a first time domain unit occupied by a second SRS resource set in a second slot,
the third position is used to indicate a starting position of a time domain interval for transmission of an uplink channel located between the first position and the second position, and
the fourth position is used to indicate an ending position of the time domain interval for the transmission of the uplink channel located between the first position and the second position.

2. The method according to claim 1, wherein
a time domain interval between the first position and the third position is greater than first interval and guard interval in a case where a transmission antenna at the first position is the same as a transmission antenna of the uplink channel,
the time domain interval between the first position and the third position is greater than second interval and the guard interval in a case where the transmission antenna at the first position is different from the transmission antenna of the uplink channel,
a time domain interval between the fourth position and the second position is greater than the first interval and the guard interval in a case where the transmission antenna of the uplink channel is the same as a transmission antenna at the second position, and
the time domain interval between the fourth position and the second position is greater than the second interval and guard interval in a case where the transmission antenna of the uplink channel is different from the transmission antenna at the second position.

3. The method according to claim 2, wherein
the first interval and the second interval are pre-configured.

4. The method according to claim 1, further comprising:
transmitting a switch capacity to the network device, and the switch capacity comprises a first capacity and a second capacity, wherein
the first capacity is used to indicate time domain interval required for switching between an SRS resource set and the uplink channel in a case where an antenna of the SRS resource set is the same as an antenna of the uplink channel, and
the second capacity is used to indicate time domain interval required for switching between the SRS resource set and the uplink channel in a case where the antenna of the SRS resource set is different from the antenna of the uplink channel.

5. The method according to claim 4, wherein
a time domain interval between the first position and the third position is greater than the time domain interval indicated by the first capacity and greater than guard interval in a case where a transmission antenna at the first position is the same as a transmission antenna of the uplink channel,
the time domain interval between the first position and the third position is greater than the time domain interval indicated by the second capacity and greater than the guard interval in a case where the transmission antenna at the first position is different from the transmission antenna of the uplink channel,
a time domain interval between the fourth position and the second position is greater than the time domain interval indicated by the first capacity and greater than the guard interval in a case where the transmission antenna of the uplink channel is the same as the transmission antenna at the second position, and
the time domain interval between the fourth position and the second position is greater than the time domain interval indicated by the second capacity and greater than the guard interval in a case where the transmission antenna of the uplink channel is different from the transmission antenna at the second position.

6. A method for transmitting time domain resource configuration information, performed by a network device, comprising:
transmitting time domain transmission configuration information to user equipment, and the time domain transmission configuration information comprises a first position, a second position, a third position, and a fourth position, wherein
the first position is used to indicate a time domain position of a last time domain unit occupied by a first sounding reference signal (SRS) resource set in a first slot,
the second position is used to indicate a time domain position of a first time domain unit occupied by a second SRS resource set in a second slot,
the third position is used to indicate a starting position of a time domain interval for transmission of an uplink channel located between the first position and the second position, and
the fourth position is used to indicate an ending position of the time domain interval for the transmission of the uplink channel located between the first position and the second position.

7. The method according to claim 6, wherein
a time domain interval between the first position and the third position is greater than first interval and guard interval in a case where a transmission antenna at the first position is the same as a transmission antenna of the uplink channel,
the time domain interval between the first position and the third position is greater than second interval and the guard interval in a case where the transmission antenna at the first position is different from the transmission antenna of the uplink channel,
a time domain interval between the fourth position and the second position is greater than the first interval and the guard interval in a case where the transmission antenna of the uplink channel is the same as a transmission antenna at the second position, and
the time domain interval between the fourth position and the second position is greater than the second interval and guard interval in a case where the transmission antenna of the uplink channel is different from the transmission antenna at the second position.

8. The method according to claim 7, further comprising:
determining the first interval and the second interval that are pre-configured.

9. The method according to claim 6, further comprising:
receiving a switch capacity transmitted by the user equipment, and the switch capacity comprises a first capacity and a second capacity, wherein
the first capacity is used to indicate time domain interval required for switching between an SRS resource set and the uplink channel in a case where an antenna of the SRS resource set is the same as an antenna of the uplink channel, and
the second capacity is used to indicate time domain interval required for switching between the SRS resource set and the uplink channel in a case where the antenna of the SRS resource set is different from the antenna of the uplink channel.

10. The method according to claim 9, wherein
a time domain interval between the first position and the third position is greater than the time domain interval indicated by the first capacity and greater than guard interval in a case where a transmission antenna at the first position is the same as a transmission antenna of the uplink channel;
the time domain interval between the first position and the third position is greater than the time domain interval indicated by the second capacity and greater than the guard interval in a case where the transmission antenna at the first position is different from the transmission antenna of the uplink channel,
a time domain interval between the fourth position and the second position is greater than the time domain interval indicated by the first capacity and greater than the guard interval in a case where the transmission antenna of the uplink channel is the same as the transmission antenna at the second position, and
the time domain interval between the fourth position and the second position is greater than the time domain interval indicated by the second capacity and greater than the guard interval in a case where the transmission antenna of the uplink channel is different from the transmission antenna at the second position.

11-12. (canceled)

13. A communication device, comprising:
a memory configured to store a computer program; and
one or more processors are collectively configured to execute the computer program, and cause the communication device to:
receive time domain transmission configuration information transmitted by a network device, and the time domain transmission configuration information comprises a first position, a second position, a third position, and a fourth position, wherein
the first position is used to indicate a time domain position of a last time domain unit occupied by a first sounding reference signal (SRS) resource set in a first slot,
the second position is used to indicate a time domain position of a first time domain unit occupied by a second SRS resource set in a second slot,
the third position is used to indicate a starting position of a time domain interval for transmission of an uplink channel located between the first position and the second position, and
the fourth position is used to indicate an ending position of the time domain interval for the transmission of the uplink channel located between the first position and the second position.

14. A communication device, comprising
a memory configured to store a computer program; and
one or more processors are collectively configured to execute the computer program, and cause the communication device to implement the method according to claim 6.

15. A non-transitory computer-readable storage medium storing one or more programs, where the one or more programs are configured to be executed by one or more processors of a processing device, and the one or more programs include instructions, wherein the instructions, when executed by the processing device, cause the processing device to perform the method according to claim 1.

16. A non-transitory computer-readable storage medium storing one or more programs, where the one or more programs are configured to be executed by one or more processors of a processing device, and the one or more programs include instructions, wherein the instructions, when executed by the processing device, cause the processing device to perform the method according to claim 6.

17. The method according to claim 2, wherein
the first interval and the second interval are determined according to a protocol.

18. The method according to claim 7, further comprising:
determining the first interval and the second interval according to a protocol.

19. The communication device according to claim 13, wherein
a time domain interval between the first position and the third position is greater than first interval and guard interval in a case where a transmission antenna at the first position is the same as a transmission antenna of the uplink channel,
the time domain interval between the first position and the third position is greater than second interval and the guard interval in a case where the transmission antenna at the first position is different from the transmission antenna of the uplink channel,
a time domain interval between the fourth position and the second position is greater than the first interval and the guard interval in a case where the transmission antenna of the uplink channel is the same as a transmission antenna at the second position, and
the time domain interval between the fourth position and the second position is greater than the second interval and guard interval in a case where the transmission antenna of the uplink channel is different from the transmission antenna at the second position.

20. The communication device according to claim 19, wherein
the first interval and the second interval are pre-configured, or
the first interval and the second interval are determined according to a protocol.

21. The communication device according to claim 13, wherein
the one or more processors are collectively configured to transmit a switch capacity to the network device, and the switch capacity comprises a first capacity and a second capacity,
the first capacity is used to indicate time domain interval required for switching between an SRS resource set and the uplink channel in a case where an antenna of the SRS resource set is the same as an antenna of the uplink channel, and
the second capacity is used to indicate time domain interval required for switching between the SRS resource set and the uplink channel in a case where the antenna of the SRS resource set is different from the antenna of the uplink channel.

22. The communication device according to claim 21, wherein
a time domain interval between the first position and the third position is greater than the time domain interval indicated by the first capacity and greater than guard interval in a case where a transmission antenna at the first position is the same as a transmission antenna of the uplink channel,
the time domain interval between the first position and the third position is greater than the time domain interval indicated by the second capacity and greater than the guard interval in a case where the transmission antenna at the first position is different from the transmission antenna of the uplink channel,
a time domain interval between the fourth position and the second position is greater than the time domain interval indicated by the first capacity and greater than the guard interval in a case where the transmission antenna of the uplink channel is the same as the transmission antenna at the second position, and
the time domain interval between the fourth position and the second position is greater than the time domain interval indicated by the second capacity and greater than the guard interval in a case where the transmission antenna of the uplink channel is different from the transmission antenna at the second position.
